(19) United States
(12) Patent Application Publication
(10) Pub. No.: US 2002/0147109 A1
(43) Pub. Date: Oct. 10, 2002

(54) Sorbent composition

(75) Inventors: Yermiahu Branover, Omer (IL); Shaul Lesin, Meitar (IL); Stanislav Sinatov, Kiryat-Ono (IL); Leon Afremov, Ehud (IL); Gregory Pipko, Katrin (IL)

Correspondence Address: FOLEY AND LARDNER, SUITE 500, 3000 K STREET NW, WASHINGTON, DC, 20007, US

(73) Assignee: SOLMECS (ISRAEL) LTD.

(21) Appl. No.: 10/042,387

(22) Filed: Jan. 11, 2002

(30) Foreign Application Priority Data
Jul. 3, 2000 (IL) PCT/IL00/00385
Jul. 11, 1999 (IL) 130,882

(51) Int. Cl. B01J 20/22

(52) U.S. Cl. 502/401; 423/229

(57) ABSTRACT

The invention provides a solid sorbent composition for removal of carbon dioxide and other acidic components from a gaseous stream, said composition being a product of a reaction of a mixture of at least one liquid absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides and mixtures thereof, said absorbent being capable of absorbing carbon dioxide and other acidic components and said reaction product being formed by heating the above mixture to effect a chemical reaction between the components of the above mixture with formation of a reaction product wherein said liquid absorbent material and said hardener combine upon heating to form said solid sorbent composition.

### FIELD OF INVENTION

The present invention relates to a sorbent composition for removal of carbon dioxide and other acidic components from a gaseous stream, the use thereof and a method for preparing the same.

### BACKGROUND ART

Carbon dioxide is one of the greenhouse gases, i.e., one of those gases considered to be a major threat to the environment due to the greenhouse effect attributable thereto.

As reported in “Costs of Curbing CO₂ Emissions Analyzed”, C&En 4 (May 18, 1992), the annual damage to the U.S. economy from the doubling of CO₂ emission (expected to occur between 2025 and 2050), would be about $60 billion, or 1% of the gross domestic product.

Two bills that aim to stabilize carbon dioxide at 1990 levels by 2000 have been introduced in the Congress of the U.S. An amendment to the energy bill introduced would stabilize greenhouse emissions.

Reduction in the emissions of CO₂ and other acidic components has become increasingly more important because of the deteriorating ambient air qualities in many industrial countries. The increasing concern over acid rain, the tightening of emission standards, and the push for the use of more coal to satisfy the energy needs, all point to an urgent need for more efficient and more economic processes. Research and development has been intensified in many countries, including the United States, England, Germany, Japan, and Russia, as reported e.g., in a) Bienstock, J. H. Field, S. Katell, and K. D. Plants, “Evaluation of Dry Processes for Removing Sulfur Dioxide from Power Plant Flue Gases.” JAPCA 15 459 (1965); and b) J. H. Field, L. W. Brunn, W. P. Haynes and H. E. Benson, “Cost Estimates of Liquid-Scrubbing Processes for Removal of Sulfur Dioxide from Flue Gases”, JAPCA 7 109 (1957). In fiscal year 1992 DOE's Office of Industrial Technologies proposed several awards totaling $550,000 for initial R&D work on innovative concepts to utilize waste CO₂.

In the prior art there are many suggested methods for separating carbon dioxide and other acidic components from gases containing the same. Some of these methods are characterized by the following processes:

a) Chemical Absorption processes;

b) Physical Absorption processes;

c) Physical Adsorption processes;

d) Membrane Separation processes; and

e) Cryogenic Separatation processes

Currently, the well-known and most used chemical materials for carbon dioxide (CO₂) removal from flue gases are water solutions of monoethanolamine (MEA) and potassium carbonate (Na)K₂CO₃ and the only industrial method of CO₂ removal is its chemical absorption by liquid phase absorbents mentioned above with the formation of carbon dioxide salt of monoethanolamine or potassium bicarbonate according to the equations:

K₂CO₃+CO₂+H₂O→2KHCO₃ (1)

2C₂H₄OHNH₂+CO₂+H₂O→(C₂H₄OHNH₃)₂·CO₃ (2)

A carbon dioxide salt of monoethanolamine, when heated above 120° C., releases carbon dioxide converting back into monoethanolamine and regenerating into the initial solution.

Potassium bicarbonate (Na)K₂CO₃, when heated above 120° C., gives off carbon dioxide converting into potassium carbonate, which is capable of cooling again to absorb CO₂ according to the equations:

2KHCO₃→K₂CO₃+H₂O+CO₂ (3)

(C₂H₄OHNH₃)₂·CO₃=2C₂H₄OHNH₂+H₂O+CO₂ (4)

Additional known chemical reactions for absorption of other acidic components are:

K₂CO₃+2HCl→2KCl+CO₂+H₂O (5)

2KHCO₃+SO₂→K₂SO₃+2CO₂+H₂O (6)

K₂CO₃+3NO₂→2KNO₃+NO+CO₂ (7)

C₂H₄OHNH₂+HCl→C₂H₄OHNH₂·HCl (8)

2C₂H₄OHNH₂+H₂S→(C₂H₄OHNH₃)₂·S (9)

C₂H₄OHNH₂+NO₂+H₂O→C₂H₄OHNH₃·NO₃ (10)

The drawbacks of the above are continuous carry-over of the solution by the gas stream, cumbersome and relatively complicated equipment, pollution of the solution with different admixtures and contamination of the environment by the carryover of solution drops. Furthermore, monoethanolamine vapors carried over to the atmosphere also present an ecological danger. Finally, the economic indexes of the MEA-based chemical absorption method are dramatically impaired when it is applied to gas streams with low initial CO₂ content.

As mentioned above, the known methods of chemical absorption are based on liquid-phase sorbents. There is a great difference between the use of liquid-phase sorbents and solid-phase sorbents.

Both with liquid-phase absorption and solid-phase adsorption, the rate of the processes is determined by the gas diffusion velocity into solvent solution or into granulated sorbent. In turn, diffusion velocity depends on the surface area of the solution drops or of the sorbent granules. The surface area of solution drops is relatively small and, consequently, the diffusion velocity in liquid phase is small, which substantially retards the process of chemical absorption.

There are known physical adsorption processes which utilize another class of highly porous materials, such as zeolites and activated carbon.

In porous granules, however, the area of gas contact surface with sorbent is 200-300 m²/g, as opposed to the area of drop surface 200-300 cm²/g, i.e., the difference in surfaced area is by several orders of magnitude, therefore the rate of gas adsorption by solid sorbent also increases by several orders, as compared to gas absorption by a liquid sorbent.

The main drawback of known solid sorbents and the processes of physical adsorption is their low adsorption capacity. When used in large-scale applications, the use of low adsorption capacity sorbents results in large capital investment and high energy consumption.

The present inventors have found a new class of solid sorbents which can overcome the disadvantages of known liquid solvents used in chemical absorption processes and known solid sorbents used in physical adsorption processes. The recyclable sorbents which are now proposed can promote high efficiency and inexpensive solid-phase processes of chemical adsorption of CO₂ and other acidic components from various gaseous streams, including flue gas with a low initial CO₂ concentration from large-scale power plants.

### DISCLOSURE OF THE INVENTION

Thus, according to the present invention there is provided a solid sorbent composition for removal of carbon dioxide and other acidic components from a gaseous stream, said composition being a product of a reaction of a mixture of at least one liquid absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides and mixtures thereof, said absorbent being capable of absorbing carbon dioxide and other acidic components and said reaction product being formed by heating the above mixture to effect a chemical reaction between the components of the above mixture with formation of a reaction product wherein said liquid absorbent material and said hardener combine upon heating to form said solid sorbent composition.

In a preferred embodiment of the present invention the liquid component is present in an amount of at least 40 wt/wt %, whereas said hardener is present in an amount of at least 10 wt/wt %.

The other acidic components of the present invention are selected from the group consisting of SO₂, H₂S, HCl and NO₂.

Preferably, the solid sorbent is introduced into said gaseous stream at a first temperature and upon saturation of said sorbent with carbon dioxide said solid sorbent is heated to a second higher temperature, at which said carbon dioxide is released, thereby enabling the recycling of said solid sorbent for reintroduction into said gaseous stream.

In preferred embodiments of the present invention said solid sorbent is introduced into said gaseous stream at a temperature lower than 80° C. , and upon saturation of said absorbent material with carbon dioxide said solid sorbent is heated to a temperature higher than 85° C., whereby said carbon dioxide is released, thereby enabling the recycling of said solid sorbent for reintroduction into said gaseous stream.

In other preferred embodiments of the present invention said sorbent is introduced into the gaseous stream at a temperature lower than 60° C., and upon saturation of said absorbent material with carbon dioxide, said solid sorbent is heated to a temperature higher than 65° C., whereby said carbon dioxide is released, thereby enabling the reintroduction of said solid sorbent into said gaseous stream.

In especially preferred embodiments of the present invention said solid sorbent is introduced into said gaseous stream at a first temperature and upon saturation of said absorbent material with carbon dioxide said solid sorbent is heated to a second higher temperature of between 65° C. and 125° C., at which said carbon dioxide is released, thereby enabling the recycling of said solid sorbent for reintroduction into said gaseous stream.

In a preferred embodiment of the present invention the gaseous stream includes moisture which has either existed therein or is added to the gaseous stream. In addition, moisture may be added to the sorbent prior to the introduction into the gaseous stream.

In another aspect of the invention there is provided a method for preparing a solid sorbent composition as defined hereinbefore for removal of carbon dioxide and other acidic components from a gaseous stream, comprising:

a) mixing at least one absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides thereof, said absorbent material being capable of absorbing said carbon dioxide and other acidic components when in a liquid state;

b) heating the above mixture to effect a chemical reaction between the components of the above mixture with formation of a reaction product;

c) processing the above reaction product into a granulated form; and

d) drying said granulated sorbent.

In especially preferred embodiments of the present invention there is provided said method for preparing a solid sorbent composition, wherein said mixture is heated at a temperature of up to 100° C.

In a preferred embodiment of the present invention there is provided a method for preparing a solid sorbent composition, wherein said liquid component is present in an amount of at least 40 wt/wt %.

In a further preferred embodiment the hardener is present in an amount of at least 10 wt/wt %.

According to the present invention the other acidic components are selected from the group consisting of SO₂, H₂S, HCl and NO₂.

The compounds according to the present invention which are capable of absorbing CO₂ from a gas mixture to form corresponding carbonates which decompose easily are liquid amino alcohols such as monoethanolamine, diethanolamine, triethanolamine, propanolamine, diglycolamine, diisopropanolamine and methyldiethanolamine. When in contact with carbon dioxide, amines form salt-like compounds, e.g., carbonates and/or bicarbonates of amines are heated to a temperature higher than 120° C., these compounds are decomposed, releasing CO₂ and regenerated into the initial amines. These amino alcohols can be used alone as illustrated in example 3 or can be used in combination with a sodium carbonate, a sodium bicarbonate, a potassium carbonate, a potassium bicarbonate and mixtures thereof, as illustrated in example 4.

The above carbonates which are in a hydrated state absorb CO₂ from the gas stream, and are converted into bicarbonates. The bicarbonates release when heated up to temperatures greater than 120° C., with the subsequent conversion into carbonates.

In GB 1,356,996 there is described a process for the removal of gaseous chlorine compounds from gases utilizing a solid sorbent material which is a product of a liquid absorbent (NaOH in solution) which is capable of absorbing carbon dioxide and calcium oxide as a hardener and discloses in general the use of an absorbent which contains and alkaline earth metal oxide, hydroxide or carbonate or a compound capable of being decomposed into the same or a mixture of such an oxide, hydroxide, carbonate or decomposable compound with an alkali metal oxide, hydroxide carbonate or compound capable of being decomposed into the same but does not teach or suggest the use of a solid sorbent composition for removal of carbon dioxide and other acidic components from a gaseous stream, said composition being a product of a reaction of a mixture of at least one liquid absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides and mixtures thereof and the advantages thereof as illustrated in the examples hereinafter.

In U.S. Pat. No. 5,480,625 there is described carbon dioxide sorption using a metal oxide-alkali metal carbonate sorbent, however, as seen from the chemistry of the reactions as described in column 1 of said patent, said patent teaches the use of a metal oxide which becomes a carbonate and then releases CO₂ upon regeneration, however, the only oxide having a regeneration at a reasonable temperature is silver oxide as described therein which is expensive for use. In contradistinction according to the present invention there is provided and utilized a sorbent composition being a product of a reaction of a mixture of at least one liquid absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides and mixtures thereof, said absorbent material being capable of absorbing carbon dioxide and other acidic components, wherein, said solid sorbent is introduced into said gaseous stream at a first temperature and upon saturation of said absorbent material with carbon dioxide said solid sorbent is heated to a second higher temperature of between 65° C. and 125° C., at which said carbon dioxide is released from said absorbent material as defined above, thereby enabling the recycling of said solid sorbent for reintroduction into said gaseous stream.

Thus said US patent does not teach or suggest the absorbent materials of the present invention or their use, as opposed to the use of oxides, for efficient absorption and regeneration as taught for the first time herein.

In the present invention, amines are used in a solidified phase, utilizing their ability to make compounds with certain oxides and to form the corresponding oxi-compounds as they become solid.

In GB 2,267,096 there is also taught a solid particulate absorbent material which absorbent material comprises sodium hydroxide and/or potassium hydroxide; alumina and/or zinc oxide; and lime, however, said patent does not teach or suggest the absorbent materials of the present invention or the advantages of the use thereof.

The sorbent compositions of the present invention are utilized during the solidification of saturated solutions of potassium or sodium carbonates and/or bicarbonates, ethanolamines and other amines capable of forming compounds with CO₂ and decomposing when the temperature is elevated higher than 65° C., releasing CO₂ and returning to the initial state. In so doing, the solidification is effected with the help of oxides of alkaline-earth and some other metals such as zinc, aluminum, magnesium, etc.

After the solidification reaction, part of the above saturated solution precipitates on solid oxi-compounds in the form of their corresponding carbonates and/or bicarbonates.

The sorbent compositions of the present invention are used to remove CO₂ from the gas stream by the chemical reaction which is carried out in the direction of sorption at high humidity and when all the above compositions are in hydrated state. CO₂ is removed by the reactions shown in equations (1) and (2) above at a temperature below 80° C. After the sorbent composition saturates with CO₂, a reverse chemical reaction is carried out in the desorption direction, according to equations (3) and (4) above, accompanied by the release of the CO₂ that was extracted in the direct reaction stage. This is achieved by heating the sorbent to temperatures exceeding 65° C. which makes it return to its initial state.

Thus, the above sorbent compositions are used in a method of CO₂ chemical adsorption which is effected cyclically and is accompanied by periodic cooling of a sorbent to <60° C., providing for the sorption initialization process and its heating by more than 65° C., providing for the desorption initialization process.

A sorbent of the present invention does not impose rigid requirements to its macro- and micro structure. Because of this, the price of the sorbent will be low in comparison to the prices of commonly used zeolites and activated carbon. Moreover, a sorbent which has been used numerous times can be utilized as a valuable slow release fertilizer after its multicycle operation and loss of its adsorptive capacity.

The sorbent compositions of the present invention can be also used for removing other acidic components such as SO₂, NO₂, H₂S, HCl, etc. from gaseous streams. However, the chemical compounds, which are formed when the said acidic components are taken up by sorbents, may be decomposed in some cases only at temperatures much higher than 150° C.-200° C. and this often makes sorbent regeneration economically disadvantageous or impossible. Thus, the method of chemical adsorption of acidic components from gaseous streams will be preferably within the framework of direct reaction stage (sorption) shown in equations 5-10, after which sorbents saturated by acidic compounds should be replaced or regenerated by exposure to high temperatures, if possible.

As will be realized, the following features are uniquely advantageous to the present invention: inexpensive sorbent, possible recovery of low-temperature waste heat for regeneration of the sorbent, a higher chemical reaction rate, a higher adsorbtive capability which allows the use of less sorbent material, The use of smaller amounts of sorbents, in addition to the narrow temperature range of the reversible chemical reaction allows for conservation of energy and the elimination of damaging effects to the sorbent in the presence of water vapor.

In addition, the used sorbent after deactivation can be utilized as fertilizer for K₂CO₃ sorbents or after dissolution and purification it can be used to prepare new portions of CO₂ sorbents.

The hydro-oxides of alkaline-earth metals according to the present invention are preferably Ca(OH)₂, Mg(OH)₂, and Ba(OH)₂.

The oxides and hydro-oxides of zinc, aluminum and magnesium according to the present invention are preferably Al₂O₃, Al(OH)₃, ZnO, MgO and Zn(OH)₂.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### COMPARATIVE EXAMPLE 1

160 g of potassium carbonate (K₂CO₃) is dissolved at 100° C. in 106.0 g of boiled water with continuous stirring. Then, with continuous stirring, 104 g of zinc oxide is added. The obtained mixture is cooled down to 40° C. and extruded in an extruder with a 2-3 mm hole diameter. The obtained granules are used for CO₂ removal from flue gas with 5.1% (v/v) CO₂ concentration in multiple cycles.

### COMPARATIVE EXAMPLE 2

The procedure of Example 1 is repeated, but after ZnO (or magnesium oxide) addition, 30 g of K₂CO₃ is added under continuous mixing. The obtained material is used for CO₂ removal from flue gas in multiple cycles.

### EXAMPLE 3

62 g of monoethanolamine (NH₂CH₂CH₂OH) is saturated with CO₂ and is mixed with 20 g of MgO with continuous stirring at 80° C. After granulating and drying, the material is used to remove CO₂ from natural gas in multiple cycles.

### EXAMPLE 4

150 g of Na₂CO₃ (sodium carbonate) is dissolved in 100 g of water at 90° C. with continuous mixing. 120 g of aluminum oxide is added to the obtained mixture with stirring at 80° C. 40 g of diethanolamine (OHC₂H₄NHC₂H₄OH) is added with mixing. The obtained material is dried and granulated. The granules are used to remove CO₂ from gases.

### COMPARATIVE EXAMPLE 5

Specimen No. 1 (The sorbent produced in Example 1)
Air stream at initial CO₂ concentration of 5.1%

| | Test duration, hr | | | | | |
|---|---|---|---|---|---|---|
| | 2 | 4 | 6 | 8 | | 20 |
| CO₂ recovery level, % | 38 | 30 | 24 | 58 | | 16 |
| Total adsorptivity, % (W/W) | | | | | 29.5 | |
| Total adsorptivity after 6 desorptions, | | | | | 11.8 | |
| % (W/W) | | | | | | |

### EXAMPLE 6

Specimen No. 4 (The sorbent produced in Example 4)
Air stream at initial Cso₂ concentration of 5.1%

| | Test Duration, hr | | | | |
|---|---|---|---|---|---|
| | 1 | 2 | 3 | 4 | |
| CO₂ recovery level, % | 100 | 100 | 98 | 34 | |
| Total adsorptivity after six desorptions, | | | | | 22.2 |
| % (W/W) | | | | | |

### EXAMPLE 7

Specification No. 5 (The Sorbent Produced in Example 1)

Humidified air stream at initial CO₂ concentration of 5.1% (w/w)

Multicycle test: 40 cycles

Duration of the processes in each cycle:

absorption—2 hr.

desorption—2 hr.

Mixture Velocity at the sorbent bed inlet: 0.02 m/s

Average CO₂ recovery level: 58% at the max. sorbent temperature of 51° C. in absorption process and 125° C. in desorption process.

As will be noted from the results of Comparative Example 5 and Example 6, the sorbent produced in Example 4 has totally absorbtivity after six desorptions which is twice that of the total absorbtivity after 6 desorptions of the sorbent product in example 1.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A solid sorbent composition for removal of carbon dioxide and other acidic components from a gaseous stream, said composition being a product of a reaction of a mixture of at least one liquid absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides and mixtures thereof, said absorbent being capable of absorbing carbon dioxide and other acidic components and said reaction product being formed by heating the above mixture to effect a chemical reaction between the components of the above mixture with formation of a reaction product wherein said liquid absorbent material and said hardener combine upon heating to form said solid sorbent composition.

2. The solid sorbent composition according to claim 1, wherein said absorbent material is present in an amount of at least 40 wt/wt %.

3. The solid sorbent composition according to claim 1, wherein said hardener is present in an amount of at least 10 wt/wt %.

4. The solid sorbent composition according to claim 1, wherein said other acidic components are selected from the group consisting of SO₂, H₂S, HCl and NO₂

5. The use of the solid sorbent composition of claim 1, for removal of carbon dioxide from a gaseous stream wherein said solid sorbent is introduced into said gaseous stream at a first temperature and upon saturation of said absorbent material with carbon dioxide said solid sorbent is heated to a second higher temperature, at which said carbon dioxide is released, thereby enabling the recycling of said solid sorbent for reintroduction into said gaseous stream.

6. The use of the solid sorbent composition of claim 1, for removal of carbon dioxide from a gaseous stream, wherein said solid sorbent is introduced into said gaseous stream at a temperature lower than 80° C., and upon saturation of said absorbent material with carbon dioxide said solid sorbent is heated to a temperature higher than 85° C., whereby said carbon dioxide is released, thereby enabling the recycling of said solid sorbent for reintroduction into said gaseous stream.

7. The use of the solid sorbent composition of claim 1, for removal of carbon dioxide from a gaseous stream, wherein said solid sorbent is introduced into said gaseous stream at a temperature lower than 60° C. , and upon saturation of said absorbent material with carbon dioxide said solid sorbent is heated to a temperature higher than 65° C., whereby said carbon dioxide is released, thereby enabling the recycling of said solid sorbent for reintroduction into said gaseous stream.

8. The use of the solid sorbent composition as claimed in claim 5, wherein said gaseous stream includes moisture.

9. The use of the solid sorbent composition as claimed in claim 5, wherein moisture is added to the gaseous stream.

10. The use of the solid sorbent composition as claimed in claim 5, wherein said sorbent is moisturized prior to the introduction thereof into the gaseous stream.

11. The use of the solid sorbent composition of claim 1, for removal of other acidic components from a gaseous stream, wherein said solid sorbent is introduced into said gaseous stream, and upon saturation of said absorbent material with said acidic components said sorbent is replaced.

12. The use of a solid sorbent composition of claim 1 for removal of carbon dioxide from a gaseous stream wherein said solid sorbent is introduced into said gaseous stream at a first temperature and upon saturation of said absorbent material with carbon dioxide said solid sorbent is heated to a second higher temperature of between 65° C. and 125° C., at which said carbon dioxide is released, thereby enabling the recycling of said solid sorbent for reintroduction into said gaseous stream.

13. A method for preparing a solid sorbent composition of claim 1 for removal of carbon dioxide and other acidic components from a gaseous stream, comprising:
e) mixing at least one absorbent material selected from the group consisting of amino alcohols and amino alcohols in combination with a sodium carbonate, a sodium bicarbonate, a potassium carbonate, a potassium bicarbonate and mixtures thereof, with at least one hardener selected from the group consisting of at least one metal oxide, wherein said metal is selected from the group consisting of zinc, aluminum, magnesium, alkaline earth metal oxides thereof, said absorbent material being capable of absorbing said carbon dioxide and other acidic components when in a liquid state;
f) heating the above mixture to effect a chemical reaction between the components of the above mixture with formation of a reaction product;
g) processing the above reaction product into a granulated form; and
h) drying said granulated sorbent.

14. A method according to claim 12, wherein said mixture is heated at a temperature of up to 100° C.

15. The method for preparing a solid sorbent composition according to claim 12, wherein said liquid component is present in an amount of at least 40 wt/wt %.

16. The method for preparing a solid sorbent composition according to claim 12, wherein said hardener is present in an amount of at least 10 wt/wt %.

17. The method for preparing a solid sorbent composition according to claim 12, wherein said other acidic components are selected from the group consisting of SO₂, H₂S, HCl and NO₂.
